(19) United States
(12) Patent Application Publication
(10) Pub. No.: US 2002/0150252 A1
(43) Pub. Date: Oct. 17, 2002

(54) Secure intellectual property for a generated field programmable gate array

(75) Inventor: Dale Wong, San Francisco, CA (US)

Correspondence Address: GARY T. AKA, 12930 SARATOGA AVENUE, SUITE D1, SARATOGA, CA, 95070, US

(73) Assignee: Leopard Logic, Inc., Cupertino, CA (US)

(21) Appl. No.: 10/105,874

(22) Filed: Mar. 25, 2002

Related U.S. Application Data
(60) Provisional application No. 60/279,237, filed on Mar. 27, 2001.

(51) Int. Cl. H04L 9/00

(52) U.S. Cl. 380/277

(57) ABSTRACT

A way of protecting the configuration bits of the user of a configurable integrated circuit is described. The user-configurable integrated circuit has a decryption circuit block which decrypts configuration bits which have been encrypted by a plurality of encryption keys corresponding to a plurality of corresponding decryption keys for programming the integrated circuit into a desired configuration. The decryption circuit block receives the plurality of decryption keys from a corresponding plurality of decryption key circuits, at least one of which is embedded in the integrated circuit so as to prevent accessibility of the decryption key. Other decryption key circuits may be part of the integrated circuit or off-chip for accessibility of their decryption keys for ready identification of their owners; still other decryption key circuits may be embedded in the integrated circuit for inaccessibility. Such an arrangement permits the protection of the user's configuration from competitors and of the providers' IP from unauthorized usage by the user of the integrated circuit.

### CROSS-REFERENCES TO RELATED APPLICATIONS

This patent application claims priority from Provisional Patent Application No. 60/279, 237, filed Mar. 27, 2001, and is hereby incorporated by reference.

### BACKGROUND OF THE INVENTION

The present invention relates to user-configurable integrated circuits and, in particular, to the protection of the user-configurations of FPGA (Field Programmable Gate Array) integrated circuits or FPGA cores within integrated circuits.

FPGAs are integrated circuits whose functionalities are designated by the users of the FPGA. The user programs the FPGA (hence the term, “field programmable”) to perform the functions desired by the user, i.e., to configure the FPGA.

In a conventional FPGA, the integrated circuit device is prefabricated as uncommitted logic and the user of the device specifies, or programs, the configuration of the logic as suits his or her intended application in the form of a configuration bitstream. The configuration bitstream are typically stored as a computer file, converted to a ROM or EEPROM resident on the user's application board, and loaded into the FPGA for infield configuration. A major concern for users of these reusable FPGA's is the vulnerability of the configuration bitstream to reverse engineering by competitors and the resulting loss of their intellectual property, i.e., the implementation of the user's application as realized in the configured FPGA.

In a conventional FPGA methodology, the configuration bitstream follows a fixed format that is required by the FPGA's hard-wired configuration loader circuitry. It is a straight forward process for a competitor to reverse engineer a configuration bitstream by defining a “dictionary” of configurations for the FPGA. A dictionary can be developed by using the FPGA's readily available design tools to create the corresponding configuration bitstream for each potential FPGA logic cell. By placing a single cell at each possible FPGA location, the configuration format for cell placement can be defined. Similarly, the configuration of the FPGA's interconnect resources can be defined. With such a dictionary, it is a simple pattern matching exercise to extract the original logic schematic from a user's configuration bitstream. This brute force attack is feasible because, although the number of possible logic cells may be large, the number of likely logic cells in a real design is relatively small.

Simply encrypting the configuration bitstream does not improve security. As long as the FPGA device is prefabricated so that all devices use the same configuration loader, and as long as the FPGA design tools are publicly available, the same dictionary attack can be applied. Attempts to improve security by making the design tools user-specific, by allowing the user to specify an encryption key for a software encrypter and decrypter of the configuration bits, are vulnerable to software hacking to intercept the decrypted configuration bitstream. Furthermore, attempts to make the configuration loader user-specific simply by configuring some of the FPGA logic as a decryption stage for the configuration loader doesn't help either. The configuration bitstream of the decryption stage is still vulnerable to a dictionary attack, and once that decryption is cracked, the whole of the configuration bitstream can be cracked.

Hence there is a need for a better way of securing the intellectual property (IP)of an FPGA user than has been done up to now. Such a secure methodology becomes possible if the FPGA can be custom generated by the user. This is the case, for example, when the user is generating an FPGA core to be embedded within the user's Application Specific Integrated Circuit (ASIC). Additionally, it would be beneficial if the IP of parties other than the FPGA user which IP is also used to configure the FPGA is secured also. The present invention addresses these problems.

### SUMMARY OF THE INVENTION

The present invention provides for a user-configurable integrated circuit capable of being programmed into a desired configuration responsive to configuration bits which define the desired configuration. The user-configurable integrated circuit has a first decryption key circuit; and a decryption circuit block which decrypts configuration bits encrypted by at least two encryption keys corresponding to a first decryption key and a second decryption key into configuration bits for programming the integrated circuit into the desired configuration. The decryption circuit block receives the first key from the first decryption key circuit and the second key from a second decryption key circuit. The second decryption key circuit may be located on the integrated circuit or off-chip and its key is readily accessible. In contrast, the first key which is to be held within the integrated circuit user is not. The second key may be used by an IP provider to help configure the integrated circuit, or by the party which provided the design of the FPGA to the user.

The present invention further provides for additional decryption keys and decryption key circuits to protect the IP of other IP providers.

### BRIEF DESCRIPTION OF THE DRAWINGS

FIG. 1 is a block diagram of the configuration logic loader for an FPGA, according to one embodiment of the present invention;

FIG. 2 is a particular implementation of the FIG. 1 configuration logic loader;

FIG.3 is a detailed block diagram of a particular implementation of the configuration loader block in FIG. 1;

FIG. 4 is a detailed block diagram of the decryption block of FIG. 3 for one encryption/decryption scheme;

FIG. 5 is a representation of the decryption key circuit in register form; and

FIG. 6. is a flow chart of the generation of an FPGA in accordance with the present invention.

### DESCRIPTION OF THE SPECIFIC EMBODIMENTS

As explained above, an FPGA is a user-configurable integrated circuit. Conventionally, an FPGA has logic cells of varying size and functionality, depending upon the FPGA's architecture, with an interconnection network by which the logic cells are to be interconnected. Both the logic cells and the interconnection network are programmable by configuration bits so that the logic cells and their interconnections are set to the user's desired configuration. In other cases, the logic cells and interconnection network of an FPGA are part of a larger integrated circuit, which has portions of the device defined for particular functions and operations for a specific application, i.e., an ASIC. This programmable portion of an FPGA, often termed an FPGA core, provides flexibility for the ASIC by creating programmable interconnections and/or logic between the defined circuit portions.

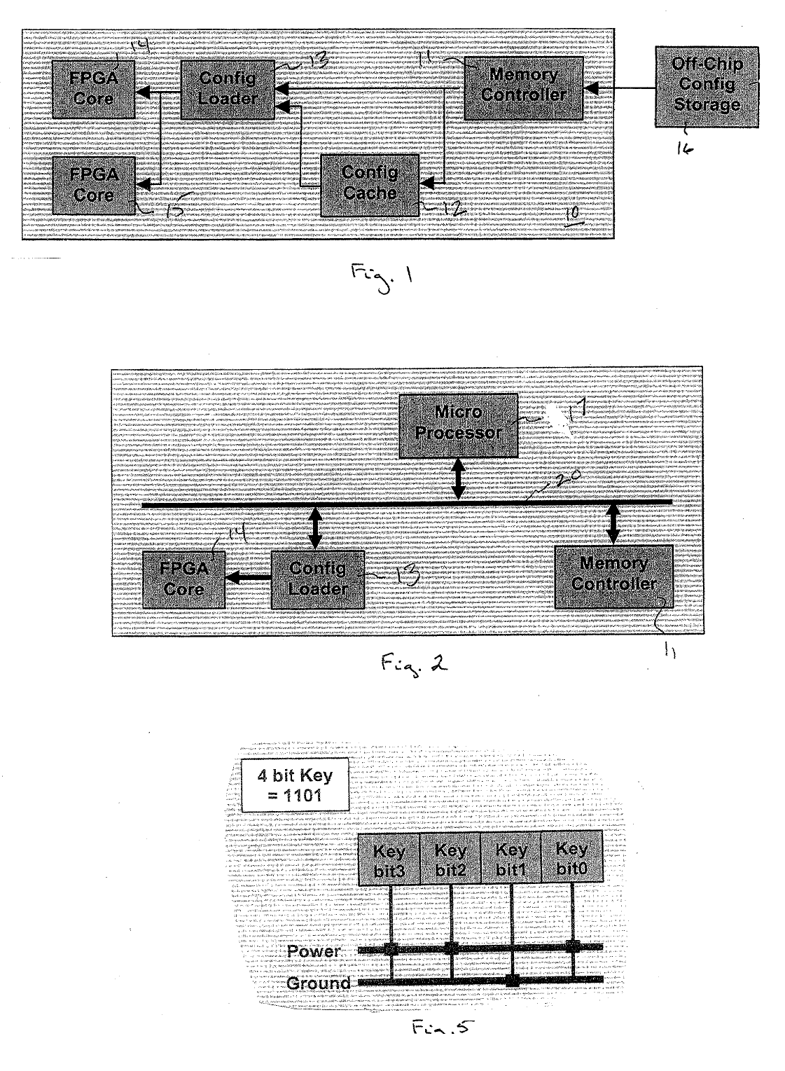

In any case, configuration bits must be loaded to program an FPGA core whether it belongs to an FPGA or an ASIC. FIG. 1 illustrates the hardware logic configuration loader circuitry with decryption for an integrated circuit 10, according to an embodiment of the present invention. As described above, the configuration bits are stored in an off-chip configuration storage 16, typically an EEPROM. The integrated circuit 10 has a memory controller block 11 which is connected to an optional configuration cache 12 and a configuration loader block 13. The configuration loader block 13, in turn, is connected to FPGA cores 14 and 15. Operationally the off-chip configuration storage 16 is interfaced by the memory controller block 11 which can send the configuration bitstream either directly to the configuration loader block 13, or indirectly to the configuration cache 13 for future loading. When the configuration loader block 13 is invoked, it processes the configuration bitstream and redirects the configuration bits to the FPGA core 14 and 15.

The configuration loading process may operate autonomously under the control of the configuration loader, or alternatively, may operate under the control of a microprocessor 17, which may be either off-chip or on-chip as shown in FIG. 2.

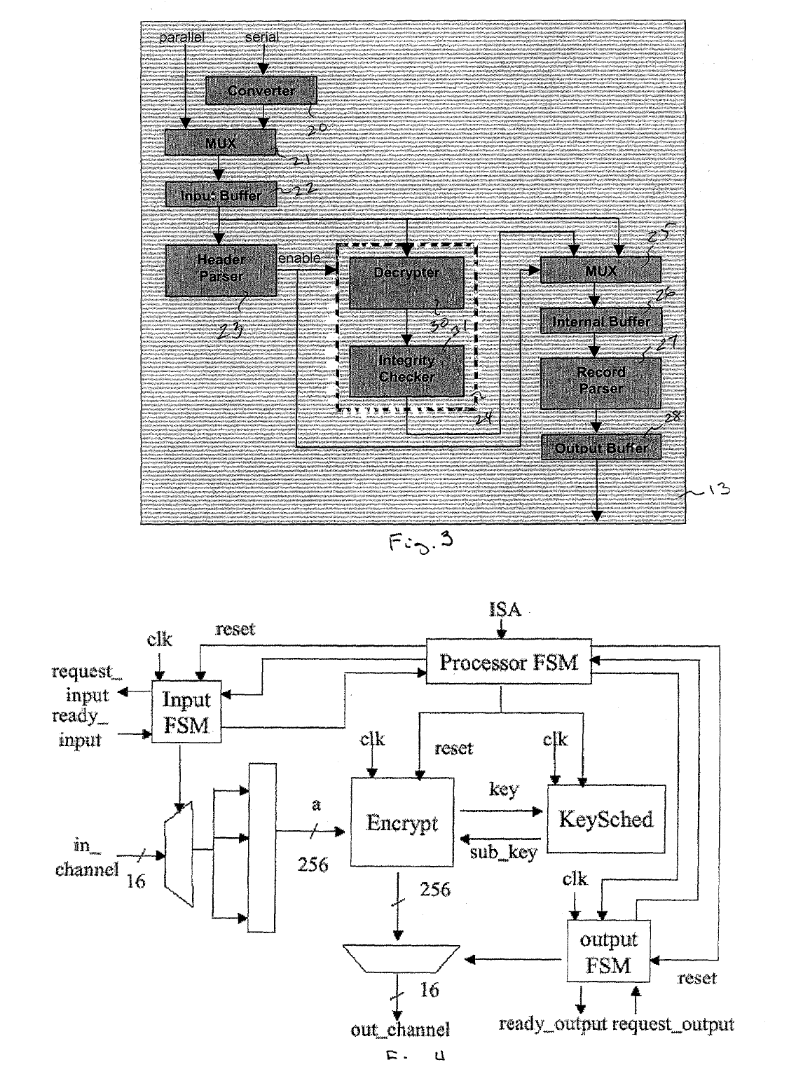

Within the configuration loader block 13, there is implemented a hardware decryption function. A more detailed view of a particular implementation of the configuration loader block 13 is shown in FIG. 3. To handle the configuration bitstream in either parallel or serial mode, the configuration loader block 13 has a multiplexer 21 which an one input connected to a converter 20 and a second input which is capable of receiving configuration bits in parallel. The output of the multiplexer 21 is connected to an input buffer 22 which has its output connected in parallel to a header parser 23, a decrypter/integrity sub-block 24, and a second multiplexer 25. The output of the header parser 23 is connected to the decrypter/integrity sub-block 24 and the second multiplexer 25 as an enabling control signal. The output of the decrypter/integrity sub-block 24 forms a second input to the second multiplexer 25 which has its output connected to an internal buffer 26 which, in turn, has its output connected to a record parser 27. The output of the record parser 27 is connected to an output buffer 28.

The configuration loader block 13 receives the configuration bitstream in either parallel or serial bit mode. If the configuration bitstream is in serial mode, the converter 20 buffers the bits to build up a full record. A record is, for example, 128 bits of configuration data. As the bits stream in, each complete record is collected by the input buffer 22 through the multiplexer 21. If the configuration bitstream is in parallel mode, the multiplexer 21 receives a complete record from the second input and passes the record to the input buffer 22.

The data in the buffer 23 are parsed by the header parser 23. Any configuration bitstream begins with the configuration bitstream header. The configuration bitstream header specifies, among other things, whether or not the logic configuration data is encrypted, which encryption algorithm was used, and the version number of the encrypter used. The configuration bitstream header records themselves are never encrypted. The configuration bitstream header also specifies the data integrity checking mechanism used for the logic configuration data.

After parsing the configuration bitstream header, the header parser 23 enables the appropriate decrypter unit 30 and integrity check unit 31 of the decrypter/integrity sub-block 24. Once enabled, the decrypter unit 30 and integrity checker unit 31 process the records from the input buffer 22 as they stream in. The decrypted and checked records are then passed to the internal buffer 26 via the multiplexer 25. The multiplexer 25 also supports the option of having the records bypass the decrypter/integrity sub-block 24 and its functions. The data from the internal buffer 26 is the processed by the record parser block to obtain the configuration function and location. The parsed configuration data is then presented on the output buffer 28 for programming the FPGA cores 14 and 15 to configure the desired circuit.

The decrypter unit 30 can be implemented with any of a number of standard decryption algorithms, for example, DES (Data Encryption Standard), Triple DES, AES (Advanced Encryption Standard). Hardware implementations of these encryption standards are well-known to those skilled in the field of electronic encryption. For example, one possible hardware implementation of the AES decryption function is shown in FIG. 4. A full description of a hardware implementation is found in “Comparison of the Hardware Performance of the AES Candidates Using Reconfigurable Hardware,” by Kris Gaj and Pawel Chodowiec. It should be noted that this implementation has a 128-bit decryption key circuit which provides for a decryption key for the decrypter unit 30 to properly decrypt the configuration bitstream. In the hardware block diagram of FIG. 4, the original key which starts the encryption/decryption process is found in the KeySched block.

In accordance with the present invention, the hardware decryption function requires a key, in the example above, a 128-bit key, to properly decrypt a configuration bitstream. Part of this key is chosen by the FPGA user and specified at the time the FPGA device is generated. Other parts of the key may be specified by other parties, such as the FPGA core design provider and/or third party providers, as described below.

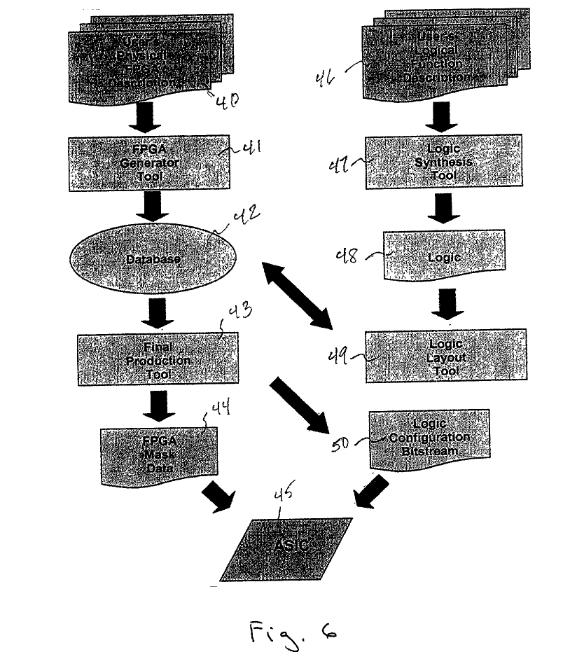

As represented by FIG. 5, one method of implementing the decryption key circuit is an n-bit register with the input to each bit tied to ground if the corresponding bit in the register is 0, and tied to power if the corresponding bit in the register is 1. There are many methods of implementing the tie-off to power or ground including, for example, metal-metal vias, pass gates, flash memory, and anti-fuses. In order to hide the key of the decryption key circuit and make it more difficult to reverse-engineer from the integrated circuit, the decryption function or just the key management portion of the decryption function, can optionally be resynthesized with the user's specified key value. Different keys, with different constant 1's and 0's, will synthesize into very different logic implementations due to constant propagation and logic minimization. This yields a couple of security advantages. First, there will no longer be obvious centralized probe points to intercept the key value. Second, every user's hardware will be different, so each one would have to be reverse-engineered anew. By embedding the key in the decryption logic of the integrated circuit, the key becomes very difficult to find. Only the user who generated the integrated circuit should know the key.

FIG. 6 illustrates how the integrated circuit is generated with the user-specified encryption key with an exemplary integrated design methodology and tool flow. The hardware decryption generator is coordinated with the software encryption generator and the same n-bit key is used to encrypt the logic configuration bitstream. The user creates his User's Physical FPGA Description 40, by specifying, for example, how many uncommitted logic cells are to be generated in the FPGA. This description is input to an FPGA Generator Tool 41 that creates a software model of the specified FPGA. This software model is stored in a central Database 42 that can also be accessed by a Logic Layout Tool 49. The other input to the Logic Layout Tool 49 is the Logic 48, which has been generated by the Logic Synthesis Tool 47 from the User's Logical Function Description 46. The output of the Logic Layout Tool 49 is a complete logic configuration which would implement the user's Logical Function if loaded into the generated FPGA. This configuration is also stored in the central Database 42. From the central Database 42, the user can run the Final Production Tool 43, where he or she can specify his encryption/decryption key, and generate his FPGA Mask Data 44 and corresponding Logic configuration bitstream 50, which is now encrypted.

Thus the encrypted configuration bits must be decrypted as described previously to match the FPGA hardware. When a configuration bitstream is loaded into an FPGA and the encryption keys do not match, nonsensical configuration data will result. Depending on the design of the FPGA device, it is possible that loading nonsense configuration data may physically damage the device. For example, if power and ground are somehow connected together, destructive localized overheating can occur and permanently damage the device. This may be acceptable when a competitor is trying to reverse engineer a user's device, but this is unacceptable when it really is the user who has inadvertently specified the wrong key or loaded the wrong configuration bitstream.

An integrity check for each decrypted configuration record prevents such damage. For example, the check could be a Cyclic Redundancy Check (CRC) or a Check Sum. After each record is decrypted, the integrity check is performed by the integrity checker unit 31 (see FIG. 3), and if there is a mismatch, the configuration loading aborts by a mismatch signal from the unit 31. This solution has the additional advantage of protecting against other causes of corrupt configuration data, such as transmission errors.

Thus far the security mechanisms have described with respect to the security of the configuration bitstreams of the FPGA user. In accordance with the present invention, other parties who contribute to the Intellectual Property (IP) embodied by the configuration bitstream of the FPGA may also be protected. For example, the end user may be designing a modem chip and choose to purchase a third party DSP filter function which is completely implemented and delivered in a configuration bitstream format. In this scenario, the configuration bitstream security may also protect the third party IP provider. If the FPGA user is also the manufacturer of the FPGA device, but the design of the FPGA core was obtained from another party, the FPGA core design supplier is another provider whose IP, the FPGA core design, might need protection.

A common problem for such IP providers is the ease with which customers can neglect to pay license and royalty fees. In either soft RTL (Register Transfer Language) form or hard layout form, the IP can be freely reused or redistributed without any method of tracking licensing fees. For royalty fees, the current industry practice is to include an identifying tag in the mask data which can be read by the silicon foundry during manufacture, but these tags are easily removed by users. There is ongoing research on digital “watermarking” techniques, but all techniques so far have drawbacks in terms of either security, ease of tracking, or standardization.

As in the case for the decryption key circuit for the FPGA user, there is also a decryption key circuit for the IP provider. However, the key in this circuit is readily accessible. There is no need to hide the key. For example, one embodiment of the present invention uses the industry standard IEEE 1149.1 JTAG Device Identification Register combined with the user specified encryption key to encrypt and decrypt the configuration bitstream. Without a correct key in the Device Identification Register, the configuration bitstream will not decrypt correctly and the IP is unusable. The Device Identification Register is a 32-bit shift register, of which bits 1-11 are an assigned Manufacturer ID, and bits 12-27 are the Device ID. The Manufacturer ID is that of the FPGA generator provider. The Device ID can be a combination of the generated FPGA Device ID and any third party IP Device ID. By arrangement between the FPGA provider and the third party IP provider, the IP can be made publicly available in an encrypted form which only the FPGA generator can decrypt for inclusion in an end user's design. The FPGA decryption circuit block will have its own embedded decryption key circuit, known to the FPGA core design provider and the third party IP provider, and unknown to the FPGA user. This protects third party IP provider from having his encrypted bitstream decrypted by the FPGA user so that third party IP is secure from the FPGA user. With this industry standard JTAG mechanism in place, anyone can easily check the devices for the Identification Register and track IP usage.

It should be noted that the JTAG Device Identification Register described above is a concatenation of two decryption key circuits, one to hold the key for the FPGA provider and the other to hold the key for the IP provider. Of course, more decryption key circuits may be used for additional IP providers. The JTAG standard allows for extension with user defined registers, which can serve as additional decryption key circuits for the FPGA decryption circuit.

Furthermore, JTAG Device Identification Register is part of the FPGA device and hence these decryption key circuits are part of the integrated circuit. Since there is no need to protect the keys, the decryption key circuits for the IP providers may also be located off-chip in a register, for example, on the same board on which the FPGA is mounted. The register provides the IP provider key(s) to the FPGA to permit the decryption of the configuration bitstream.

Hence the present invention provides for a way by which the FPGA user can protect his configuration of the FPGA from competitors and by which the IP providers can protect their IP in the FPGA by easy monitoring of the IP usage by the FPGA user.

While the foregoing is a complete description of the embodiments of the invention, it should be evident that various modifications, alternatives and equivalents may be made and used. Accordingly, the above description should not be taken as limiting the scope of the invention which is defined by the metes and bounds of the appended claims.

What is claimed is:

1. A user-configurable integrated circuit capable of being programmed into a desired configuration responsive to configuration bits defining said desired configuration, said user-configurable integrated circuit comprising
a first decryption key circuit; and
a decryption circuit block decrypting configuration bits encrypted by at least two encryption keys corresponding to a first decryption key and a second decryption key into configuration bits for programming said integrated circuit into a desired configuration, said decryption circuit block receiving said first key from said first decryption key circuit and said second key from a second decryption key circuit.

2. The user-configurable integrated circuit of claim 1 further comprising a plurality of input/output pins and wherein said second decryption key circuit is connected at least one of said input/output pins so that said second decryption key is accessible through said at least one of said input/output pins.

3. The user-configurable integrated circuit of claim 2 further comprising said second decryption key circuit.

4. The user-configurable integrated circuit of claim 3 wherein said second decryption key circuit comprises a register for holding said second decryption key.

5. The user-configurable integrated circuit of claim 4 wherein said register comprises a JTAG register for said user-programmable integrated circuit.

6. The user-configurable integrated circuit of claim 2 wherein said decryption circuit block receives said second decryption key through at least one of said plurality of input/output pins.

7. The user-configurable integrated circuit of claim 6 wherein said second decryption key circuit comprises a register for holding said second decryption key.

8. The user-configurable integrated circuit of claim 7 wherein said register comprises a JTAG register for said user-programmable integrated circuit.

9. The user-configurable integrated circuit of claim 2 wherein first decryption key circuit is not connected to said plurality of input/output pins so that said first decryption key is accessible through one or more of said plurality of said input/output pins.

10. The user-configurable integrated circuit of claim 9 wherein said first decryption key circuit comprise embedded logic to avoid determination of said first decryption key by an analysis of said user-programmable integrated circuit.

11. The user-configurable integrated circuit of claim 2 wherein said decryption circuit block decrypts configuration bits further encrypted by a third encryption key corresponding to a third decryption key for programming said integrated circuit into a desired configuration, said decryption circuit block receiving said third key from a third decryption key circuit.

12. The user-configurable integrated circuit of claim 11 wherein said third decryption key circuit is connected at least one of said input/output pins so that said third decryption key is accessible through said at least one of said input/output pins.

13. The user-configurable integrated circuit of claim 12 further comprising said second decryption key circuit and said third decryption key circuit.

14. The user-configurable integrated circuit of claim 3 wherein said second decryption key circuit and third decryption key circuits comprise a concatenated register for holding said second and third decryption keys.

15. The user-configurable integrated circuit of claim 14 wherein said register comprises a JTAG register for said user-programmable integrated circuit.

16. The user-configurable integrated circuit of claim 11 wherein said decryption circuit block receives said second decryption key and said third decryption key through at least one of said plurality of input/output pins.

17. The user-configurable integrated circuit of claim 16 wherein said second decryption key circuit comprises a register for holding said second decryption key; and said third decryption key circuit comprises a register for holding said third decryption key.

18. The user-configurable integrated circuit of claim 17 wherein said second decryption key circuit and said third decryption key circuit comprise a concatenated register for holding said second and third decryption keys.

19. The user-configurable integrated circuit of claim 18 wherein said register comprises a JTAG register for said user-programmable integrated circuit.

20. The user-configurable integrated circuit of claim 11 further comprising said third decryption key circuit; and wherein first decryption key circuit and said third decryption key circuits are not connected to said plurality of input/output pins so that said first decryption key and said third decryption keys are accessible through one or more of said plurality of said input/output pins.

21. The user-configurable integrated circuit of claim 20 wherein said first decryption key circuit and said third decryption key circuit comprise embedded logic to avoid determination of said first decryption key and said third decryption key by an analysis of said user-programmable integrated circuit.

22. The user-configurable integrated circuit of claim 20 wherein said decryption circuit block decrypts configuration bits further encrypted by a fourth encryption key corresponding to a fourth decryption key respectively for programming said integrated circuit into a desired configuration, said decryption circuit block receiving said fourth key from a fourth decryption key circuit.

23. The user-configurable integrated circuit of claim 22 wherein said fourth decryption key circuit is connected at least one of said input/output pins so that said fourth decryption key is accessible through said at least one of said input/output pins.

24. The user-configurable integrated circuit of claim 23 further comprising said fourth decryption key circuit.

25. The user-configurable integrated circuit of claim 24 wherein said second decryption key circuit and fourth decryption key circuits comprise a concatenated register for holding said second and third decryption keys.

26. The user-configurable integrated circuit of claim 25 wherein said register comprises a JTAG register for said user-programmable integrated circuit.

27. The user-configurable integrated circuit of claim 22 wherein said decryption circuit block receives said second decryption key and said fourth decryption key through at least one of said plurality of input/output pins.

28. The user-configurable integrated circuit of claim 27 wherein said second decryption key circuit comprises a register for holding said second decryption key; and said fourth decryption key circuit comprises a register for holding said fourth decryption key.

29. The user-configurable integrated circuit of claim 28 wherein said second decryption key circuit and said fourth decryption key circuit comprise a concatenated register for holding said second and fourth decryption keys.

30. The user-configurable integrated circuit of claim 30 wherein said register comprises a JTAG register for said user-programmable integrated circuit.

31. The user-configurable integrated circuit of claim 1 comprising an ASIC having an FPGA core, said decryption block providing decrypted configuration bits for programming said FPGA core into a desired configuration of said ASIC.

32. A user-configurable integrated circuit capable of being programmed into a desired configuration responsive to configuration bits defining said desired configuration, said user-configurable integrated circuit comprising
a decryption circuit block decrypting configuration bits encrypted by a plurality of encryption keys corresponding to a plurality of corresponding plurality of decryption keys into configuration bits for programming said integrated circuit into a desired configuration, said decryption circuit block receiving said plurality of decryption keys from a corresponding plurality of decryption key circuits;
at least a first of said plurality of decryption key circuits embedded in said user-configurable integrated circuit so as to prevent accessibility of a decryption key corresponding to said at least one decryption key circuit.

33. The user-configurable integrated circuit of claim 32 further comprising a plurality of input/output pins; and wherein said decryption circuit block is externally connected to at least a second of said plurality of decryption key circuits through at least one of said plurality of input/output pins.

34. The user-configurable integrated circuit of claim 32 further comprising a plurality of input/output pins and at least a second of said plurality of decryption key circuits connected to said decryption circuit block; and wherein a decryption key corresponding to said second of said plurality of decryption key circuits accessible through at least one of said plurality of input/output pins.
